(19) United States
(12) Patent Application Publication
(10) Pub. No.: US 2014/0049590 A1
(43) Pub. Date: Feb. 20, 2014

(54) INKJET RECORDING DEVICE

(71) Applicants: Tomotaka Tateishi, Shinjuku-ku (JP); Yasuhiro Matsui, Hachioji-shi (JP)

(72) Inventors: Tomotaka Tateishi, Shinjuku-ku (JP); Yasuhiro Matsui, Hachioji-shi (JP)

(73) Assignee: KONICA MINOLTA, INC., Tokyo (JP)

(21) Appl. No.: 14/113,621

(22) PCT Filed: Apr. 25, 2012
(86) PCT No.: PCT/JP2012/061024

§ 371 Date: Oct. 24, 2013

(30) Foreign Application Priority Data
Apr. 27, 2011 (JP) 2011-099562

(51) Int. Cl. B41J 11/00

(52) U.S. Cl. CPC B41J 11/0085
USPC 347/104

(57) ABSTRACT

An inkjet recording device, using ink which changes phase between a gel or solid state and a liquid state depending on temperature includes a recording medium fixing section to which a recording medium sticks to be fixed thereon with air suction through sticking holes; a negative pressure generation section to generate a negative pressure for the air suction; and an inkjet recording head. The recording medium fixing section includes a recording medium holding layer which has the sticking holes and is maintained at a temperature for the ink to be in the gel or solid state; and a support layer which has suction holes communicating with the sticking holes and includes at least one layer to support the recording medium holding layer. The opening area of the open end of each sticking hole is smaller than that of each suction hole.

### CROSS REFERENCE TO RELATED APPLICATIONS

This is the U.S. national stage of application No. PCT/JP2012/061024, filed on 25 Apr. 2012. Priority under 35 U.S.C. §119 (a) and 35 U.S.C. §365(b) is claimed from Japanese Application No. 2011-099562, filed 27 Apr. 2011, the disclosure of which is also incorporated herein by reference.

### TECHNICAL FIELD

The present invention relates to an inkjet recording device.

### BACKGROUND ART

In recent years, rapid developments of inkjet recording methods in various fields allow recording of high-definition images with a relatively simple device. The use of such inkjet recording ranges widely, and a recording medium and an ink suitable for each purpose are used. In recent years, in particular, a recording speed has greatly increased, and developments of inkjet recording devices having capabilities for use of quick printing have been advanced.

In order to eject ink smoothly from fine nozzles of inkjet recording heads, the ink preferably has a relatively-low viscosity.

Ejecting such ink with a relatively-low viscosity and putting it on a recording medium, however, involves problems of deterioration in image quality as follows.

In the case of a recording medium that does not absorb ink well, the phenomena called bleed and beading occur, causing deterioration in image quality. The bleed is a phenomenon where different colors are mixed, and the beading is a phenomenon where the shades of the same color look like beads.

In the case of a paper medium having a high rate of ink absorption, such as a plain paper, the phenomena called feathering and strike-through occur, which are the major causes of deterioration in image quality even with a plain paper. The feathering is a phenomenon where ink runs irregularly on a paper along its paper fiber, and the strike-through is a phenomenon where ink penetrates to the back side of a sheet.

Various methods have been proposed to prevent such problems, among which is the use of a temperature-sensitive thickening ink. This method sets inkjet recording heads to a temperature different from the temperature of a recording medium to allow the ink, having a thermosensing property, to have a low viscosity at the time of ejection and a high viscosity when the ink is put on the recording medium. Such a method intends to prevent bleed, beading and feathering while ensuring a good ejection.

A technique is developed, for example, to use an ink made of substance which is in a liquid state at an ordinary temperature and is made into a solid resin when cooled after heated, and to heat nozzles of recording heads to an ink solidification temperature or higher (see Patent Literature 1, for example).

As a method of fixing and holding a recording medium at the time of inkjet recording and conveyance of the recording medium, the methods described in Patent Literatures 2 and 3 are preferably used. Specifically, the surface, opposite to the recording surface where ink is to be ejected, of a recording medium comes into contact with a support member having sticking holes. The recording medium sticks to the support member with a negative pressure suction of air through the sticking holes.

### PRIOR ART LITERATURES

### Patent Literatures

Patent Literature 1: Japanese Unexamined Patent Application Publication No. 3-71850
Patent Literature 2: Japanese Unexamined Patent Application Publication No. 2011-020377
Patent Literature 3: Japanese Unexamined Patent Application Publication No. 2011-032036

### DISCLOSURE OF INVENTION

### Problems to be Solved by the Invention

Unfortunately, the studies conducted by the inventors have found that combining the technique of temperature-sensitive thickening ink and the sticking method causes temperature variation between the portion over the sticking holes and the portion over the member around the sticking holes due to the difference in their thermal environments during a cooling process, where the ink ejected onto a recording medium changes phase into a solid state. The studies have found a resulting phenomenon of a sticking hole pattern appearing in an image due to gloss variations.

The present invention has been made in view of the problems of the conventional art and aims to provide an inkjet recording device which prevents a sticking hole pattern from appearing in an image. The inkjet recording device uses an ink to change phase between a gel state or a solid state and a liquid state depending on temperature, and includes a recording medium fixing section. The recording medium fixing section is a section to which a recording medium sticks to be fixed thereon with an air suction through sticking holes to come into contact with the recording medium.

### Means for Solving Problems

The first aspect is an inkjet recording device using an ink which changes phase between a gel state or a solid state and a liquid state depending on temperature, the device including: a recording medium fixing section to which a recording medium sticks to be fixed thereon with an air suction through sticking holes to come into contact with the recording medium; a negative pressure generation section to generate a negative pressure for the air suction; and an inkjet recording head to eject the ink in the liquid state onto the recording medium, wherein the recording medium fixing section includes: a recording medium holding layer to be maintained at a temperature for the ink to be in the gel state or the solid state, the recording medium holding layer having the sticking holes; and a support layer including at least one layer to support the recording medium holding layer, the support layer having suction holes communicating with the sticking holes, and wherein each of the sticking holes has an open end to come into contact with the recording medium, the open end having an opening area smaller than an opening area of an open end of each of the suction holes, the open end of each of the suction holes being in contact with the recording medium holding layer.

The second aspect is the inkjet recording device according to the first aspect, wherein a maximum circle fitting inside an opening of the open end of each of the sticking holes to come into contact with the recording medium has a diameter D satisfying the relation of D≦4t, wherein t is a thickness of the recording medium.

The third aspect is the inkjet recording device according to the first aspect or second aspect, wherein an aperture ratio represented by an opening area of the sticking holes occupying a surface region of the recording medium holding layer to come into contact with the recording medium is 5% or more and 75% or less.

The fourth aspect is the inkjet recording device according to any one of the first aspect to third aspect, wherein the recording medium holding layer has a thickness of 0.05 mm or more and 0.4 mm or less.

The fifth aspect is the inkjet recording device according to any one of the first aspect to fourth aspect, wherein the recording medium holding layer is made of stainless steel.

The sixth aspect is the inkjet recording device according to any one of the first aspect to fifth aspect, further including a heater to heat the recording medium fixing section to a predetermined temperature.

The seventh aspect is the inkjet recording device according to anyone of the first aspect to sixth aspect, wherein the recording medium has a thickness of 0.15 mm or less.

### Effects of the Invention

The diameter of holes made in a member depends on the thickness of the member in the direction in which the holes are made. A thinner member allows smaller holes to be made in the member but has a lower rigidity.

The present invention includes a support layer having a rigidity to maintain the shape of sticking surface where a recording medium sticks, and a recording medium holding layer having sticking holes to come into contact with a recording medium. This facilitates the creation of fine sticking holes. Specifically, the open end of each sticking hole, which is to come into contact with a recording medium, has an opening area smaller than that of the open end of each suction hole in contact with the recording medium holding layer. This reduces temperature variation between the portion over the sticking holes and the portion over the member around the sticking holes when the ink ejected onto a recording medium cools into a gel or solid state, preventing a sticking hole pattern from appearing in an image.

### BRIEF DESCRIPTION OF DRAWINGS

FIG. 1 is a schematic diagram showing the main configuration of an inkjet recording device of an embodiment of the present invention;

FIG. 2 is a schematic diagram showing a recording medium fixing section, a suction pump and a pipe connecting the fixing section and the suction pump with each other provided in an inkjet recording device of an embodiment of the present invention, the diagram including a recording medium;

FIG. 3 is graphs showing an example of temperature-viscosity characteristics of a gel ink;

FIG. 4A is a partial plan view showing a part of a recording medium holding layer and a support layer according to an embodiment of the present invention;

FIG. 4B is a cross-sectional view along the line A-A of the partial plan view showing a part of the recording medium holding layer and the support layer according to an embodiment of the present invention;

FIG. 5A is a partial plan view showing a part of a recording medium holding layer and a support layer according to a comparative example;

FIG. 5B is a cross-sectional view along the line B-B of the partial plan view showing a part of the recording medium holding layer and the support layer according to the comparative example;

FIG. 6 is graphs showing temperature change at the surface of ink according to the comparative example;

FIG. 7 is graphs showing temperature change at the surface of ink according to an example of the present invention;

FIG. 8A is a plan view showing an example of the planar shape of a sticking hole applicable to the present invention;

FIG. 8B is a plan view showing an example of the planar shape of a sticking hole applicable to the present invention;

FIG. 8C is a plan view showing an example of the planar shape of a sticking hole applicable to the present invention;

FIG. 9A is a cross-sectional view showing an example of the cross-sectional shape of a sticking hole applicable to the present invention;

FIG. 9B is a cross-sectional view showing an example of the cross-sectional shape of a sticking hole applicable to the present invention;

FIG. 9C is a cross-sectional view showing an example of the cross-sectional shape of a sticking hole applicable to the present invention;

FIG. 10A is a partial plan view showing a part of a recording medium holding layer and a support layer according to another embodiment of the present invention;

FIG. 10B is a cross-sectional view along the line C-C of the partial plan view showing a part of the recording medium holding layer and the support layer according to another embodiment of the present invention;

FIG. 11 is a graph showing existence or non-existence of generation of a sticking hole pattern, with the horizontal axis representing the thickness t of a recording medium and with the vertical axis representing the diameter D of the maximum circle fitting inside the opening of the open end of a sticking hole, the open end coming into contact with a recording medium;

FIG. 12 is a graph showing existence or non-existence of generation of a sticking hole pattern, with the horizontal axis representing the thickness t of a recording medium and with the vertical axis representing the diameter D of the maximum circle fitting inside the opening of the open end of a sticking hole, the open end coming into contact with a recording medium; and

FIG. 13 is a partial cross-sectional view of a recording medium, a recording medium holding layer and a support layer where an airflow path at the time of suction is schematically indicated by the arrows.

### EMBODIMENT FOR CARRYING OUT THE INVENTION

The best mode for carrying out the present invention is described below with reference to the drawings. Although the embodiments described below include various limitations which are technically preferable to carryout the present invention, the scope of the invention is not limited to the embodiments and examples shown in the drawings.

An inkjet recording device 1 of the present embodiment uses a temperature-sensitive thickening ink which changes phase between a gel state or a solid state and a liquid state depending on temperature.

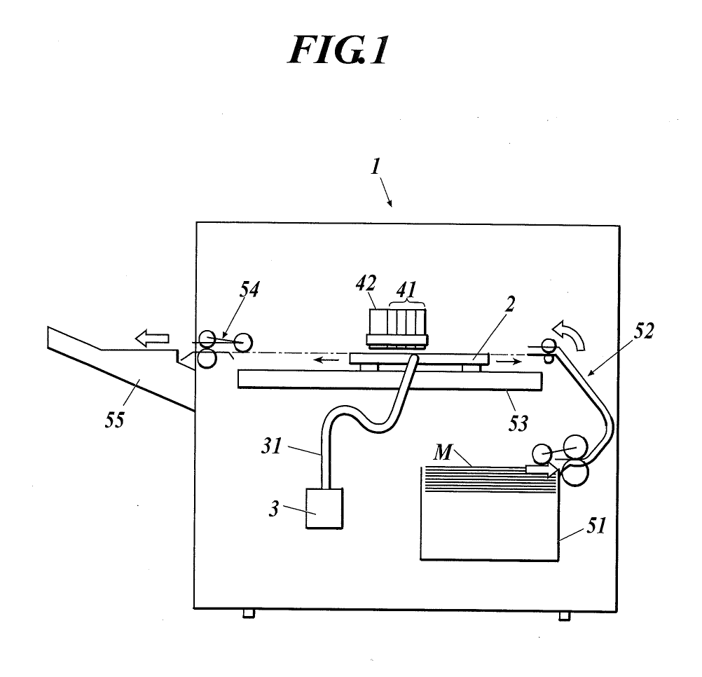

As shown in FIG. 1, the inkjet recording device 1 of the present embodiment includes a recording medium fixing section 2 to which a recording medium M sticks to be fixed thereon; a suction pump 3 as a negative pressure generation section; inkjet recording heads 41; an irradiation section 42; a paper feed tray 51 to store recording media M; a conveyance unit 52 to convey a recording medium M from the paper feed tray 51 to the recording medium fixing section 2; a movement unit 53 to move the recording medium fixing section 2; a conveyance unit 54 to convey a recording medium M from the recording medium fixing section 2 to a paper output tray 55; the paper output tray 55; and a control device (not shown) to control the overall device including a suction operation by the suction pump 3, a recording operation by the inkjet recording heads 41, turning-on of the irradiation section 42, and conveyance operations by the conveyance units 52 and 54 and the movement unit 53.

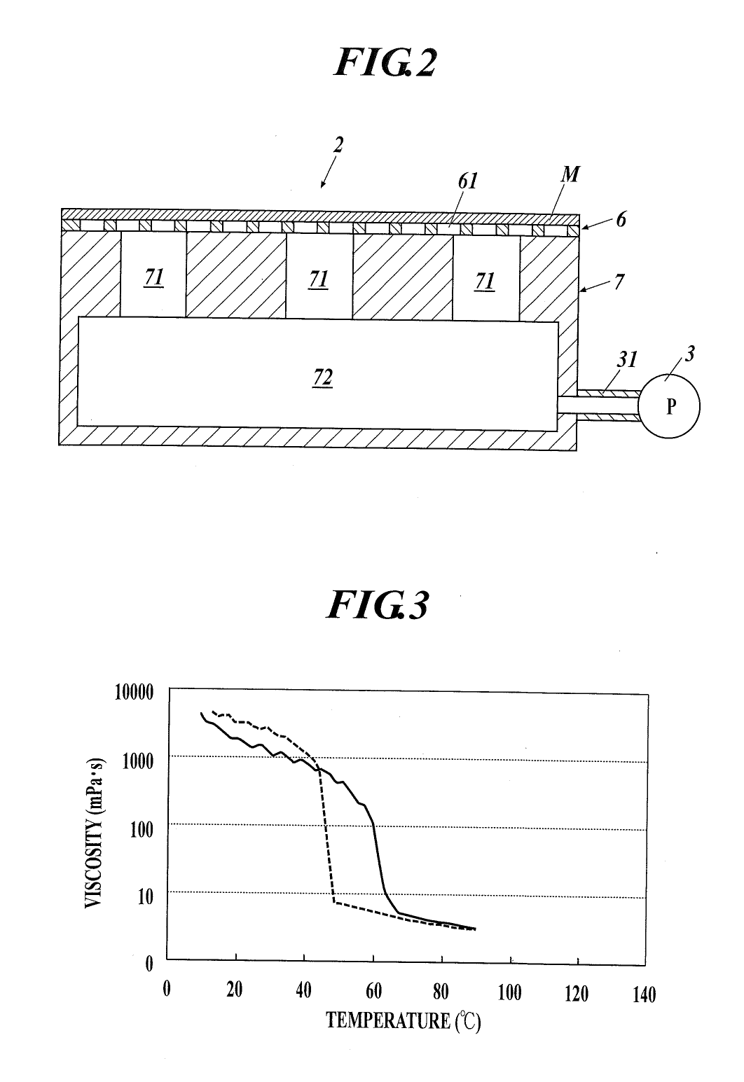

FIG. 2 shows a schematic diagram of a recording medium M, the recording medium fixing section 2, the suction pump 3 and a pipe 31 connecting the section 2 and the suction pump 3 with each other. The recording medium M, the recording medium fixing section 2 and the pipe 31 are shown in section.

As shown in FIG. 2, the recording medium fixing section 2 includes a recording medium holding layer 6 and a support layer 7. The recording medium holding layer 6 has sticking holes 61 and is maintained at a temperature for the ink to be in a gel or solid state. The support layer 7 supports the recording medium holding layer 6.

A thin plate having the sticking holes 61 is primarily used as the recording medium holding layer 6.

The support layer 7 has an internal space 72 and suction holes 71 extending from the internal space 72 to communicate with the sticking holes 61. The internal space 72 is connected to the suction pump 3 with the pipe 31.

Air suction driving by the suction pump 3 sucks a recording medium M through the pipe 31, the internal space 72, the suction holes 71 and the sticking holes 61 so that the recording medium M sticks to and is fixed to the openings of the sticking holes 61 in the surface of the recording medium holding layer 6.

The ink in the inkjet recording heads 41 is temperature-regulated to be maintained in a liquid state. A heater is provided to heat the recording medium fixing section 2 to a predetermined temperature. The heater is used to change the temperature of the ink, which has been put on a recording medium M on the recording medium fixing section 2, to such a temperature as to turn the ink into a gel or solid state. Examples of the heater include a heating wire disposed in contact with the recording medium fixing section 2 and an infrared lamp for non-contact heating.

The liquid ink is ejected from the inkjet recording heads 41 onto the recording medium M which sticks to and is fixed to the recording medium holding layer 6 as described above to form an image. The ink ejected from the inkjet recording heads 41 is put onto the recording medium M and is reduced in temperature compared to at the time of the ink ejection. This turns the ink into a gel or solid state and fixes the ink on the recording medium M.

An example of the temperature-viscosity characteristics of the ink turning into a gel state is shown in FIG. 3. The gel ink at or more than 80° C. has a viscosity of 10 [mPa·s] or less, while the viscosity becomes several thousand [mPa·s] when the ink temperature decreases to the level of a room temperature (20-30° C.).

The inkjet recording, as described above, prevents a sticking hole pattern from appearing in an image through the use of the recording medium holding layer 6 having many sticking holes 61 smaller than the suction holes 71 of the support layer 7.

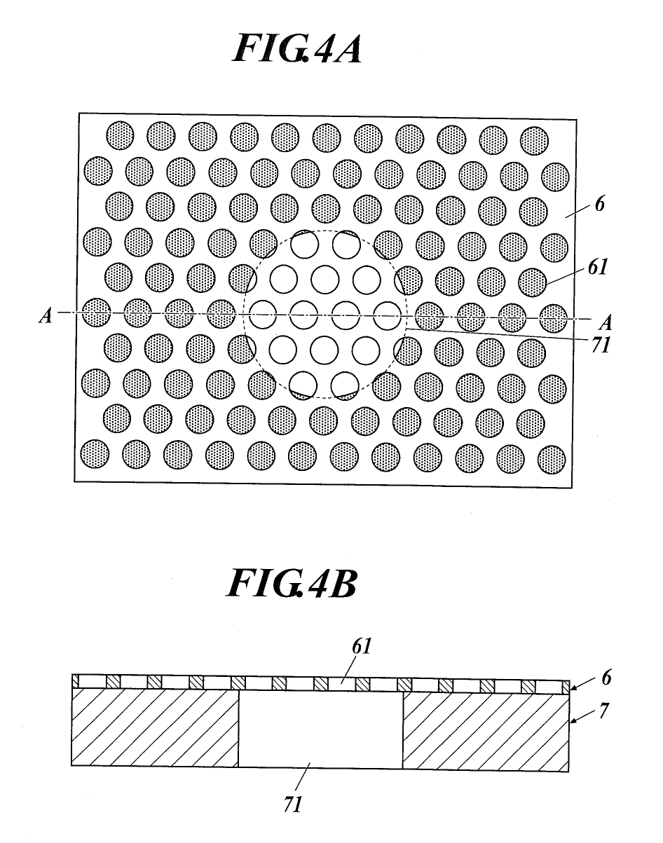

As shown in FIG. 4, a sticking hole 61 provided in the recording medium holding layer 6 has an open end to come into contact with a recording medium M (i.e., the upper end of FIG. 4B), the area of the open end being smaller than that of the open end of a suction hole 71 in contact with the recording medium holding layer 6.

As shown in FIG. 4, the recording medium holding layer 6 has the many minute sticking holes 61 arranged at nearly equal intervals. The sticking holes 61 are dispersed over the regions which coincide with the suction holes 71 and the regions around the suction holes 71. Many suction holes 71 are dispersed in every direction, too, such that the structure shown in FIG. 4 is continuously repeated.

The member having the sticking holes 61 may be laid on the member having the suction holes 71 as a method for manufacturing. Alternatively, the materials of the recording medium holding layer 6 and the support layer 7 may be integrated with each other before the formation of the sticking holes 61 and the suction holes 71. In this case, relatively small-size holes are formed in one surface to come into contact with a recording medium M as the sticking holes 61, and larger-size holes are formed in the other surface as the suction holes 71.

The sticking force at the surface where the sticking holes 61 are provided and where a recording medium M is placed is represented by (total area of openings)×(sticking pressure). Increasing the ratio of the area of the sticking holes 61 occupying the region to be covered with a recording medium M, that is, the aperture ratio, can increase the sticking force. Increasing the area of each sticking hole 61, however, tends to cause a sticking hole pattern to appear in an image. In order to increase the sticking force while preventing a sticking hole pattern from appearing in an image, minute sticking holes need to be provided in larger numbers and in higher density.

In connection with the above-mentioned matters, providing the recording medium holding layer 6 and the support layer 7 separately has the following advantageous effects.

Making many minute holes of less than φ1.0 mm, specifically φ0.4 mm, in an aluminum plate with a thickness of 5 mm involves difficult processing, for example. Since the sticking force is determined on the bases of the aperture ratio and the sticking pressure, obtaining a proper aperture ratio requires a larger number of holes as a hole diameter is smaller. Forming minute holes in the support layer 7 with a thickness of about 5 mm requires one-by-one drilling and deburring for each hole, resulting in costing too much money for manufacturing.

Forming a recording medium holding layer 6 of a stainless-steel thin plate, specifically a plate having a thickness of about 0.1 mm, enables formation of many holes having φ0.4 mm or less at a time through etching and eliminates the need for deburring, resulting low-cost manufacturing.

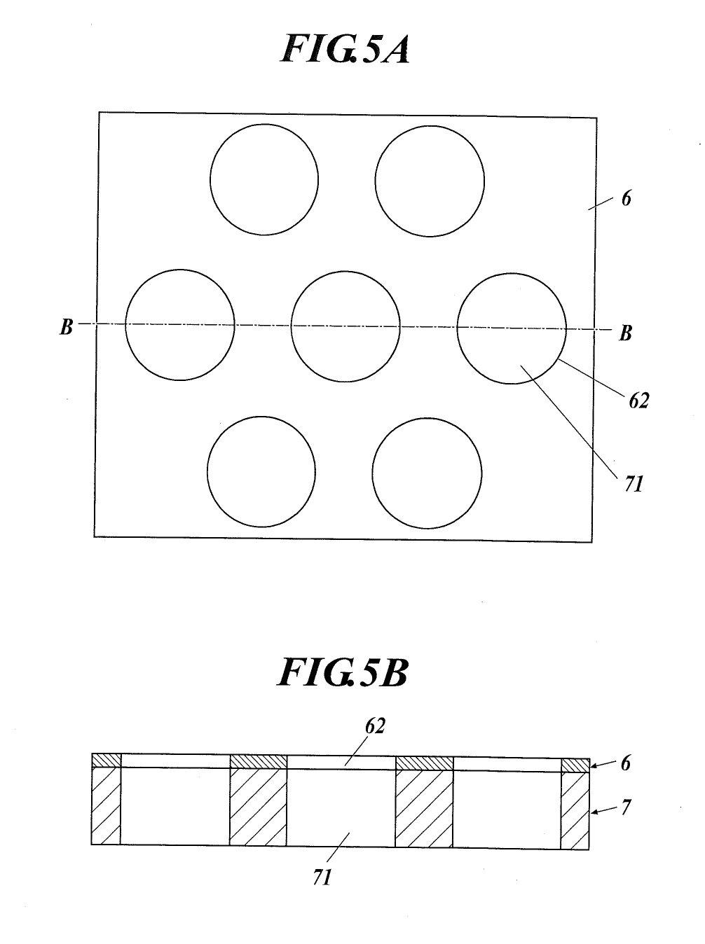

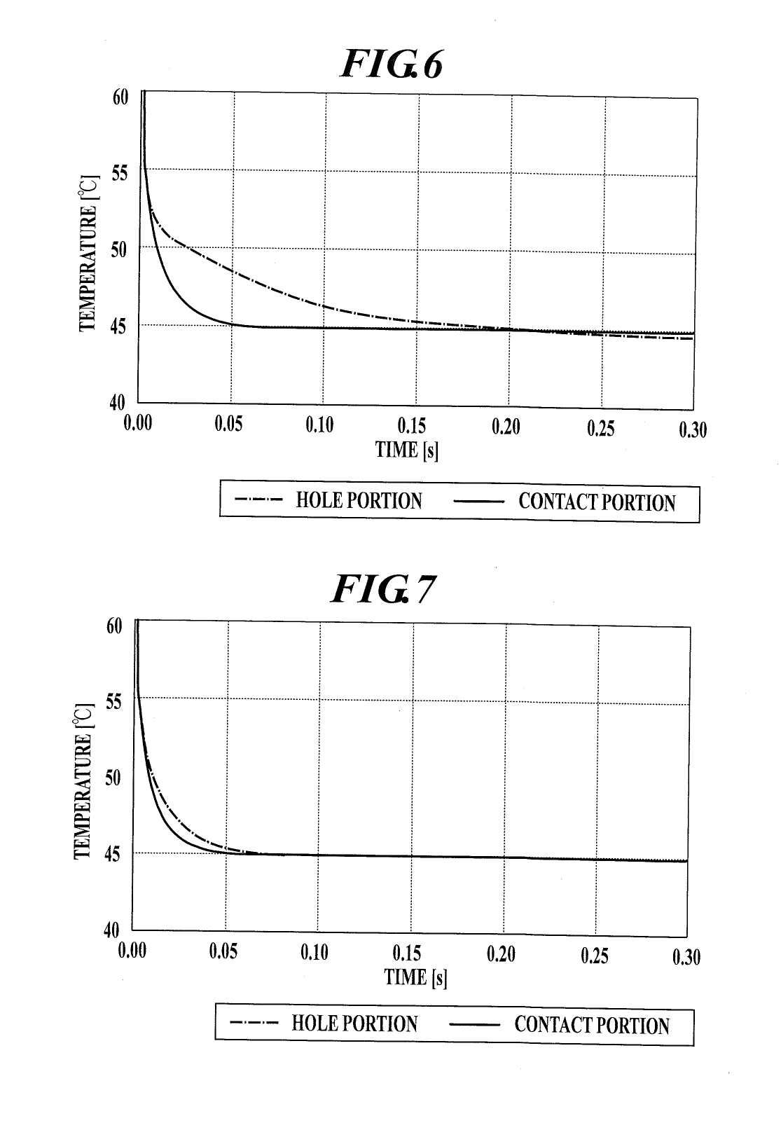

In order to ascertain the efficacy of making the sticking holes 61 smaller than the suction holes 71 of the support layer 7, inkjet image formation is performed using the recording medium fixing section configured as shown in FIG. 5 with a recording medium sticking to the recording medium fixing section. The recording medium fixing section includes a support layer 7 and a recording medium holding layer 6 laid on the support layer 7. Specifically, the support layer 7 is a 5-mm thickness aluminum having suction holes 71 of φ1.0 mm, and the recording medium holding layer 6 is a 0.1-mm thickness stainless-steel having sticking holes 62 of φ1.0 mm. The recording medium is “OK Top Coat Plus” (Oji Paper Co., Ltd.) having a thickness of 0.056 mm (basis weight of 73.3 gsm). The graphs of FIG. 6 show the changes in temperature of ink surfaces.

The graphs of FIG. 6 show the change in temperature of the ink surfaces above the centers of the φ1.0 holes (i.e., a hole portion, the dashed-dotted line graph) and the change in temperature of the ink surfaces above the portions far enough away from the φ1.0 holes, namely 2 mm away in this example, (i.e., a contact portion, the solid line graph), with the temperature of the recording medium M and the recording medium fixing section at 45° C., and with the ink ejection temperature at 90° C. The recording medium M and the recording medium fixing section are heated to 45° C. to provide a good gloss.

Comparing the two graphs in FIG. 6 with each other, a large difference in the history of ink temperature decrease is found between the hole portion (dashed-dotted line) and the contact portion (solid line). In FIG. 6, the maximum temperature difference reaches 4.0° C. between the hole portion (dashed-dotted line) and the contact portion (solid line). The difference in the history of ink temperature decrease between the hole portion and the contact portion is thought to be caused by the following reasons. At the contact portion, a good conductor of heat, such as a metal, around the sticking holes 62 is disposed under a recording medium M instead of the sticking holes 62, facilitating release of heat in the ink; while at the hole portion, heat in the ink is difficult to release due to the air under the recording medium M.

The difference in temperature history in the same image as shown in FIG. 6 causes a sticking hole pattern to appear due to the difference in gloss in the formed image when using ink to change phase between a gel state or a solid state and a liquid state depending on temperature for image formation.

While air has a thermal conductivity of 0.026 [W/(m·K)], stainless steel SUS304, carbon steel SS400 and aluminum A5052 have thermal conductivities of 16.8 [W/(m·K)], 51.6 [W/(m·K)] and 235 [W/(m·K)], respectively, namely 640-9000 times as large as that of air. Using metal as the recording medium holding layer 6 allows the difference in thermal conductivity between the hole portion (i.e., air) and the contact portion (i.e., metal) to be large enough, namely the contact portion has a thermal conductivity 640 times larger than that of the hole portion even with the use of the SUS304.

Using any of stainless steel, carbon steel and aluminum as the material of the recording medium holding layer 6 similarly gives rise to a large difference in history of ink temperature decrease between the hole portion and the contact portion.

In contrast, the recording medium fixing section configured as shown in FIG. 4, an embodiment of the present invention, is used for inkjet image formation, with a recording medium sticking to the recording medium fixing. The recording medium fixing section includes a support layer 7 and a recording medium holding layer 6 laid on the support layer 7. Specifically, the support layer 7 is a 5-mm thickness aluminum having suction holes 71 of φ1.0 mm, and the recording medium holding layer 6 is a 0.1-mm thickness stainless-steel having sticking holes 61 of φ0.4 mm. The recording medium is “OK Top Coat Plus” (Oji Paper Co., Ltd.) having a thickness of 0.056 mm (basis weight of 73.3 gsm). The graphs of FIG. 7 show the changes in temperature of ink surfaces. The other conditions are the same as those for the graphs of FIG. 6. The graphs of FIG. 7 show that the maximum temperature difference between the hole portion and the contact portion is 1.4° C., which is smaller than in the graphs of FIG. 6.

The difference between the graphs of FIG. 6 and those of FIG. 7 is caused by the difference in the diameter of the sticking holes in the recording medium holding layer 6. While the recording medium holding layer 6 having the sticking holes of φ1.0 mm causes a sticking hole pattern to appear in a formed image, the recording medium holding layer 6 having the sticking holes of φ0.4 mm does not cause the generation of a sticking hole pattern in a formed image.

In order to prevent generation of a sticking hole pattern as described above, the opening shape of each sticking hole formed in the recording medium holding layer 6 is not limited to a circle as shown in FIG. 4 but may be the shape of a tetragon, hexagon or cross. The opening shape, however, preferably meets the following conditions.

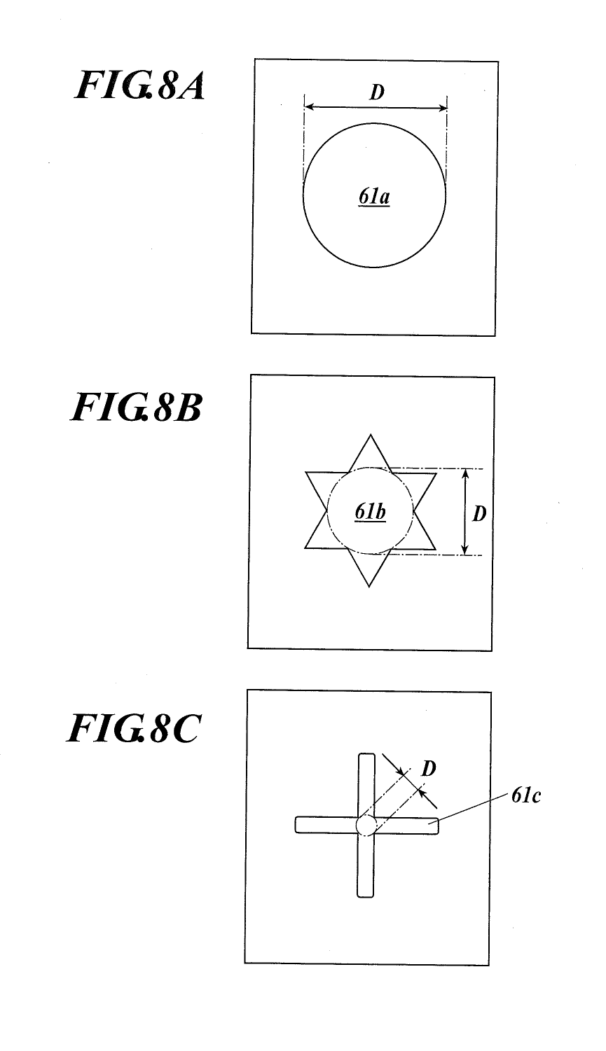

Here, a diameter D is defined with reference to FIG. 8. In the case of a circle sticking hole 61a as shown in FIG. 8A, the diameter D of the circle fitting inside an opening and having a maximum area is equal to the diameter of the sticking hole 61a. In the case of a non-circular sticking hole, e.g., a sticking hole 61b shown in FIG. 8B and a sticking hole 61c shown in FIG. 8C, the circles within the holes 61b and 61c indicated by the dashed-dotted lines are maximum circles fitting inside the openings. In this case, the diameters of the maximum circles are defined as diameters D.

Since the opening shape of a sticking hole having corners causes concentration of stress at the corners, such corners preferably are rounded.

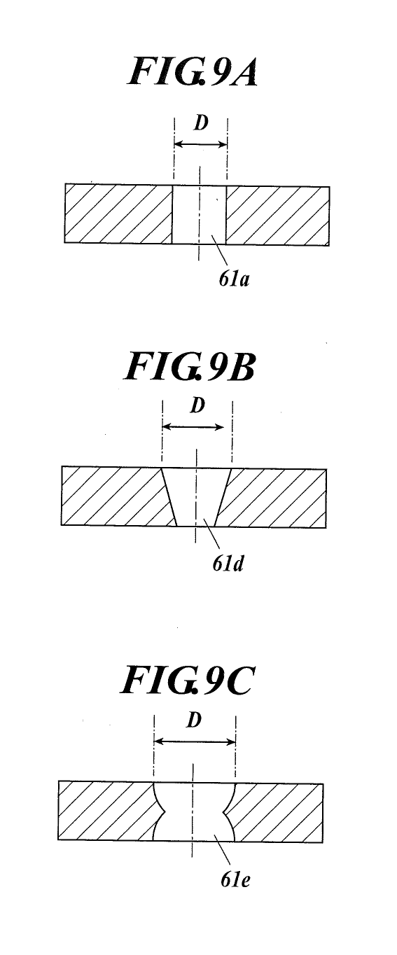

The shape of the cross-sectional surface of a sticking hole is not limited to a pillar shape. The sticking holes may be made through processing, such as drilling, laser processing and etching, to have a cross-sectional surface in various shapes. Examples of the shapes include a straight hole having a uniform diameter as shown by a sticking hole 61a of FIG. 9A, a taper hole as shown by a sticking hole 61d of FIG. 9B, and a hole whose diameter increases as getting closer to both ends as shown by a sticking hole 61e of FIG. 9C. In the case of the sticking holes 61d and 61e, a diameter D is the diameter of the maximum circle fitting inside the opening of an open end to come into contact with a recording medium.

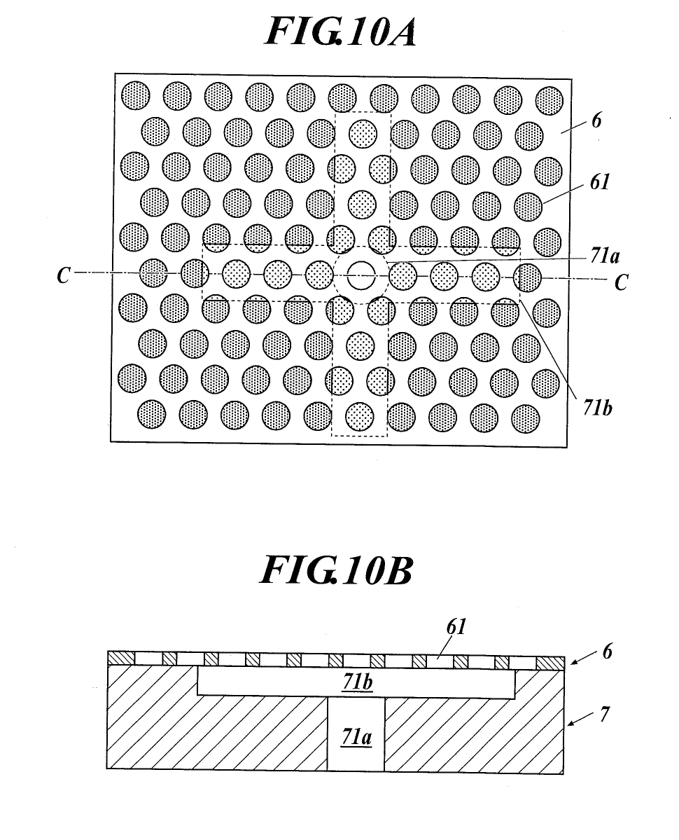

In addition, a suction hole 71 of the support layer 7 is not limited to the straight hole as shown in FIG. 4 but may include a lower hole 71a and a suction groove 71b in contact with the recording medium holding layer 6 as shown in FIG. 10.

In the case where the support layer 7 has sticking grooves 71b in its surface in contact with the recording medium holding layer 6, the opening area of a suction hole 71 in the support layer 7 means the opening area of a sticking groove 71b provided in the surface of the support layer 7 in contact with the recording medium holding layer 6.

An insufficient sticking pressure results in lack of a sticking force and may cause a recording medium M to get out of position, while an excessive sticking pressure may deform a recording medium M.

Existence or non-existence of generation of a sticking hole pattern was examined using “t” and “D” as parameters. The parameter “t” is the thickness of a recording medium M, and the parameter “D” is the diameter of the maximum circle fitting inside the opening of the open end of a sticking hole 61 to come into contact with the recording medium.

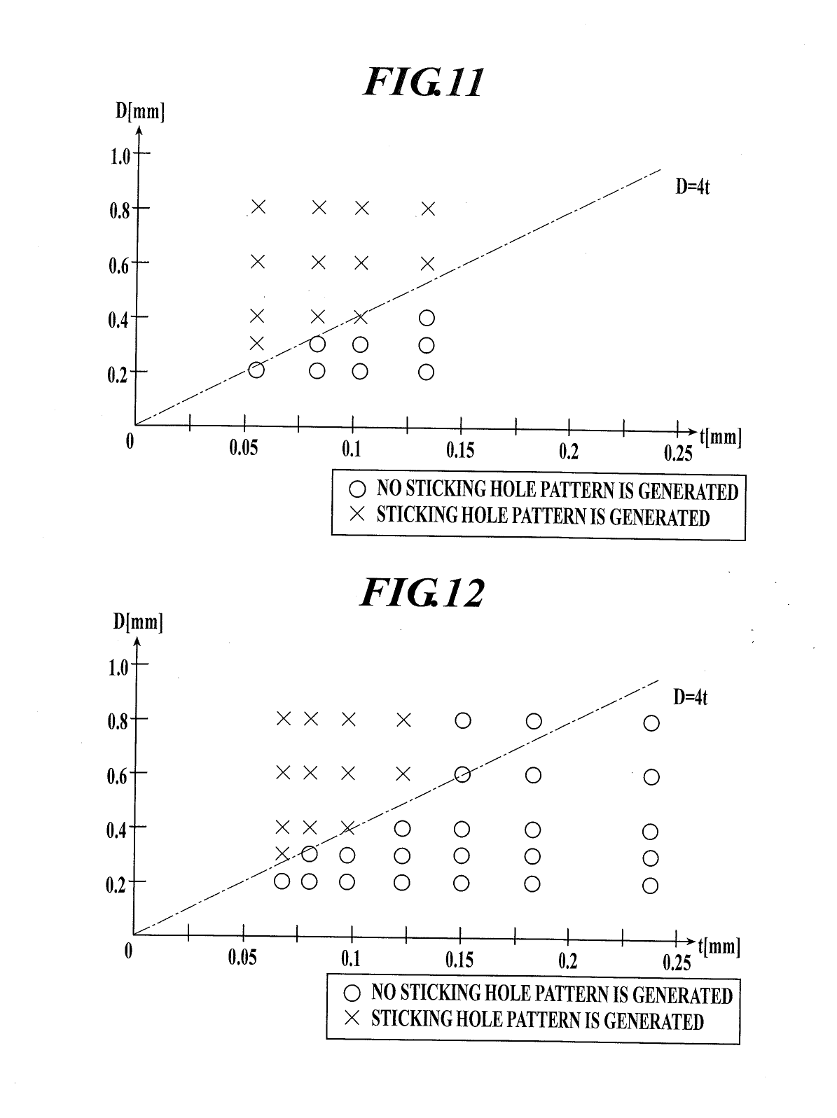

FIGS. 11 and 12 show the evaluation results regarding existence or non-existence of generation of a sticking hole pattern under the condition that the recording medium holding layer 6 made of stainless steel has a thickness of 0.1 mm and has sticking holes 61 arranged in a 60° staggered fashion at a pitch of 1.5D (aperture ratio: 40.3%). “OK Top Coat Plus” (Oji Paper Co., Ltd.) was used as a recording medium M to obtain the evaluation results shown in FIG. 11. Npi woodfree paper (Nippon Paper Industries Co., Ltd.) was used as a recording medium M to obtain the evaluation results shown in FIG. 12.

As shown in FIGS. 11 and 12, even a thin recording medium can prevent generation of a sticking hole pattern when a diameter D satisfies the relation of 1≦4t. This is because the reduction in distance from a hole portion (i.e., the portion of a recording medium M above the center of a sticking hole 61) to a contact portion (i.e., the portion of the recording medium M in contact with the recording medium holding layer 6) can reduce ink temperature variation between the hole portion and the contact portion. A thinner recording medium creates a smaller distance between the recording medium holding layer 6 and the ink on the recording medium M and tends to give rise to such a temperature variation. Hence, a thinner recording medium requires a smaller diameter D.

A thicker recording medium M creates a larger distance between the recording medium holding layer 6 and the ink on the recording medium M and has a better insulation effect, leading to reduction in ink temperature variation. A recording medium M having a thickness of more than 0.15 mm is less likely to generate a sticking hole pattern independent of a diameter D as shown in FIG. 12. The present invention thus can be effectively applied to an inkjet recording device using a recording medium M with a thickness of 0.15 mm or less, in particular.

The aperture ratio of the sticking holes 61 may be set on the basis of the diameter, the shape, the pitch and the arrangement of the sticking holes. The aperture ratio represented by the opening area of the sticking holes 61 occupying the surface region of the recording medium holding layer 6 to come into contact with a recording medium M is preferably set within the range of 5% or more and 75% or less. An aperture ratio less than 5% fails to allow a recording medium to stick with a sufficient sticking force. An aperture ratio more than 75% may deform the recording medium holding layer due to its insufficient rigidity though ensuring a sticking force. In addition, the contact portion occupying only less than 25% may fail to sufficiently reduce the temperature variation between the hole portion and the contact portion. The aperture ratio is more preferably 10% or more and 50% or less. The sticking holes 61 are preferably arranged in a 60° staggered fashion to arrange many and high-density sticking holes 61, but the arrangement fashion is not limited thereto.

The sticking force was measured in the following manner. A 0.1-mm thickness stainless-steel recording medium holding layer 6 with sticking holes 61 (φ: 0.2 mm) arranged in a 60° staggered fashion at a pitch of 0.3 mm was laid on a support layer 7 with suction holes 71 (φ: 1.0 mm) arranged in a 60° staggered fashion at a pitch of 6 mm. A sheet of paper as a recording medium M having a size of 100 mm×297 mm was made to stick with a negative pressure of 50 kPa. A peeling-off force to peel off a sheet was thus measured using a pull gauge.

The measurement result of the peeling-off force was 180 N.

The peeling-off force was also measured with a sheet of paper directly placed on the support layer 7 without providing the recording medium holding layer 6 while the other conditions are equal. In this case, the peeling-off force was 112 N.

Considering these conditions, providing the recording medium holding layer 6 reduces the aperture ratio to a recording medium compared to not providing the recording medium holding layer 6.

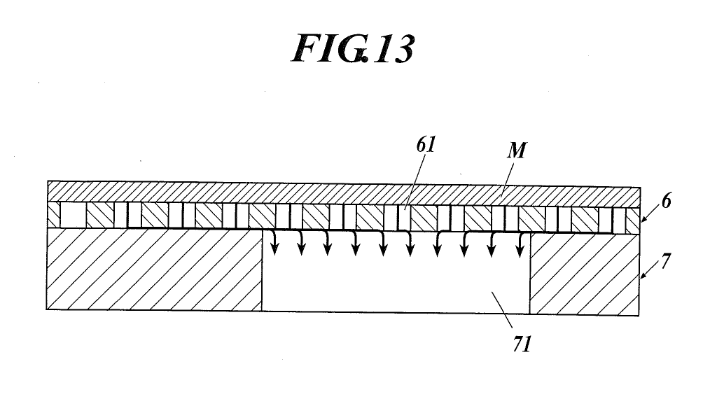

The measurement result, however, shows that providing the recording medium holding layer 6 increased the sticking force. It is contemplated that the reason is the sticking holes 61 disposed not just above the suction holes 71 of the support layer 7 also help the sticking of the recording medium M due to an air leak between the recording medium holding layer 6 and the support layer 7, as shown in FIG. 13

When some of the sticking holes 61 do not directly communicate with the suction holes 71, therefore, forming the recording medium holding layer 6 over the support layer 7 to allow an air leak between the layers 6 and 7 through the suction by the suction pump 3 enables a large sticking force more effectively than forming the layers 6 and 7 integrally.

As a method for forming the sticking holes 61, etching or laser processing is preferable for a good productivity considering the need to form many minute sticking holes 61. In the case of etching, making a pattern of holes smaller than a plate thickness is basically impossible, and the plate thickness needs to be smaller than the sticking hole diameter. Since the diameter of the sticking holes in the recording medium holding layer 6 is preferably 0.4 mm or less, the plate thickness is preferably 0.4 mm or less. In the case of laser processing, an increase in plate thickness makes the formation of holes difficult, and makes the formation of tapers still difficult if the holes can be formed. Such increase in plate thickness, therefore, precludes an increase in aperture ratio of the sticking holes 61.

The recording medium holding layer 6 needs to have a thickness of 0.05 mm or more.

The recording medium holding layer 6 having a small plate thickness may cause lack of rigidity even when the aperture ratio of the sticking holes 61 is small.

Further, the recording medium holding layer 6 having a small plate thickness may cause an insufficient thermal capacity of the recording medium holding layer 6 and cause an increase in temperature change of the recording medium holding layer 6 at the time of inkjet recording. This may increase the temperature difference between the hole portion and the contact portion, resulting in generation of a suction hole pattern.

The ratio of thermal capacities per unit area of a recording medium and the recording medium holding layer is preferably about 1:4-1:10.

The thermal capacity per unit area of the recording medium holding layer 6 made of the SUS304 is 1862 [J/(m²·K)] when the thickness is 0.4 mm, while 204 [J/(m²·K)] when the thickness is 0.05 mm. The thermal capacity per unit area of a recording medium is 102 [J/(m²·K)] when it is a woodfree paper of 0.06 mm.

The material for the recording medium holding layer 6 is preferably stainless steel to obtain a proper shape of each sticking hole and a proper aperture ratio and to ensure the rigidity of the recording medium holding layer 6. When using material other than stainless steel, a sticking hole shape, an aperture ratio and a thickness are set in light of the flexibility, the rigidity and the fatigue limit of the material to be used.

The aluminum A5052 has a tensile strength of 230 [N/mm²], while the stainless steel SUS304 has a tensile strength of 520 [N/mm²].

Since a recording medium M repeatedly sticks to and is removed from the recording medium holding layer 6, a decline in mechanical strength due to a repeated stress has to be taken into consideration.

While stainless steel has a fatigue limit for a repeated stress, aluminum does not have a clear fatigue limit and declines in a stress at rupture with many-time repeated stresses. In view of this, the material for the recording medium holding layer 6 is preferably stainless steel.

The present invention is not limited to the structure where the recording medium holding layer 6 and the support layer 7 each have a flat surface. The recording medium holding layer 6 and the support layer 7 each having a curved surface can also bring about the advantageous effects. The advantageous effects of the present invention can also be obtained when using a drum for holding and conveying a recording medium, the periphery of which drum is formed with the recording medium holding layer 6 to carry out the present invention.

Preferably-applicable inks are described in detail below.

The ink preferably used is an activating beam curable ink which is cured by being irradiated with energy rays (activating beams). The activating beam curable ink contains a gelling agent in an amount of 1 percent by mass or more but less than 10 percent by mass, and exhibits a reversible sol-gel phase transition depending on temperature. The term “so-gel phase transition” refers to a phenomenon in which a liquid state at an elevated temperature is transformed into a non-fluid gel state at a cooled temperature lower than or equal to a gelation temperature, and the non-fluid gel state is reversibly transformed into a liquid state at an elevated temperature higher than or equal to the solation temperature.

The term “gelation” used herein refers to a solidified, semi-solidified, or thickened state accompanied by sharp increases in viscosity and elasticity; for example, a lamella structure, a polymer network formed by non-covalent bonds or hydrogen bonds, a polymer network formed by physical aggregation, and an aggregated structure composed of substances each immobilized by interactions between fine particles or between deposited fine crystals. The term “solation” refers to a liquid state in which the interactions formed during the gelation are released. The term “solation temperature” refers to an elevated temperature at which a gel ink is transformed into a sol state having fluidity. The term “gelation temperature” refers to a cooled temperature at which a sol ink is transformed into a gel state having reduced fluidity.

The activating beam curable ink, which exhibits such so-gel phase transition, is transformed into a liquid state at an elevated temperature, and thus can be ejected from an inkjet recording head. Upon recording using the activating beam curable ink at an elevated temperature, ink drops on a recording medium are spontaneously cooled and rapidly solidified by a temperature difference between the ink drops and the recording medium. This can prevents poor quality of an image due to integration of adjacent dots. Unfortunately, ink drops that are readily solidified may be isolated from each other to form a rough image. The roughness may lead to inhomogeneous gloss such as extremely low gloss and unnatural glitter. Vigorous investigation by the inventors found that the control of solidifying properties of ink drops, a gelation temperature of ink, and the temperature of a recording medium within the following range can prevent poor image quality due to integration of the ink drops, and can also achieve highly natural gloss on the image. Specifically, printing with the ink which contains a gelling agent in an amount ranging of 0.1 percent by mass or more but less than 10 percent by mass and has a viscosity of 10² mPa·s or higher but lower than 10⁵ mPa·s at 25° C., under the control of the difference between the gelation temperature (T_{gel}) of ink with the gelling agent and the surface temperature (Tₛ) of the recording medium within the range of 5 to 15° C. can prevent integration of the ink drops and thus simultaneously achieve high image quality and natural gloss on an image. In this case, the temperature of the recording medium is controlled within the range of 42 to 48° C.

The inventors guess that such a phenomenon involves the following processes. When an ink drop ejected onto a recording medium is solidified before an adjacent ink drop is ejected, low gloss and unnatural glitter on an image are caused; whereas, when adjacent ink drops are solidified a certain time after the ink drops are ejected and integrated with each other, extremely poor image quality is caused due to overlap of the ink drops. Vigorous investigation by the inventors found that the control of viscosity of the ejected ink drops can prevent integration of ink drops and facilitate proper leveling of adjacent ink drops, which leads to natural gloss on an image.

Printing with the ink containing a gelling agent in an amount of 0.1 percent by mass or more but less than 10 percent by mass and exhibiting a viscosity of 10² mPa·s or higher but lower than 10⁵ mPa·s at 25° C. allows the viscosity of the ink to be controlled within the temperature range of substrate. This control can simultaneously achieve high image quality and natural gloss on an image. Such a finding is based on the following assumption: the ink having viscosity lower than 10² mPa·s at 25° C. cannot sufficiently prevent the integration of ink drops, and thus causes poor image quality within the above-described temperature range. The ink having viscosity of 10⁵ mPa·s or higher at 25° C. may exhibit high viscosity after gelation and cause a noticeable increase in viscosity during a cooling process. The viscosity of such an ink is barely controlled to an extent to be properly leveled within the above-described temperature range, which may reduce the gloss of an image. Contrarily, the ink of the present invention, which is transformed into a viscous gel having proper viscosity after gelation, can effectively inhibit the solidification of the dots, and thus achieve image quality exhibiting relatively natural gloss.

The term “homogeneous gloss” does not define an absolute gloss, e.g., a specular reflection gloss at 60 degree. It, however, refers to entirely homogeneous gloss of an image (in particular, a solid image) without partially inhomogeneous gloss of the image, e.g., unnatural glitter, undesirable decreases in gloss, and stripe inconsistencies in gloss on the image, due to microscopic differences in gloss.

Use of the activating beam curable ink under the control of the difference between the gelation temperature (T_{gel}) of the ink and the surface temperature (Tₛ) of the recording medium within the range of 5 to 15° C. can prevent poor image quality, and achieve high image quality exhibiting high sharpness of fine lines in characters and natural gloss. To achieve higher image quality, the temperature of the recording medium is preferably controlled within the range of 5 to 10° C.

The composition of the activating beam curable ink used in the present invention will now be described in sequence.

### (Gelling Agent)

The term “gelation” refers to a solidified, semi-solidified, or thickened state accompanied by sharp increases in viscosity and elasticity; for example, a lamella structure, a polymer network formed by non-covalent bonds or hydrogen bonds, a polymer network formed by physical aggregation, and an aggregate structure composed of substances each immobilized by interactions between fine particles or between deposited fine crystals.

Typical examples of gels include a thermoreversible gel and a non-thermoreversible gel. The thermoreversible gel is transformed into a fluid solution (also referred to as “sol”) when heated, while it is reversibly transformed into gel when cooled. The non-thermoreversible gel is not reversibly transformed into a fluid solution when heated once it gelates. The gel, which contains an oil gelling agent, is preferably a thermoreversible gel to prevent clogging of the recording heads.

The gelation temperature (phase transition temperature) of the activating beam curable ink is preferably 40° C. or higher but lower than 100° C., and more preferably, 45° C. or higher but 70° C. or lower. Taking into account summer environmental conditions, an ink exhibiting a phase transition at a temperature of 40° C. or higher can be stably ejected from a recording head regardless of the environment temperature during printing. An ink exhibiting a phase transition at a temperature lower than 90° C. eliminates the need for heating of an inkjet recording device to an extremely high temperature, which can reduce load on the recording heads of and the components of the ink supply system of an inkjet recording device.

The term “gelation temperature”, which refers to a temperature at which a liquid is transformed into a gel state accompanied by a rapid change in viscosity, is a synonym of a “gel transition temperature”, “gel dissolution temperature”, “phase transition temperature”, “sol-gel phase transition temperature”, and “gelation point”.

A gelation temperature of ink is calculated from a viscosity curve and a viscoelasticity curve observed with, for example, a rheometer (e.g., a stress controlled rheometer having a cone-plate, PhysicaMCR, Anton Paar Ltd.). The viscosity curve is observed during a temperature change in a sol ink at an elevated temperature under a low shear rate, whereas the viscoelasticity curve is observed during a measurement of a temperature change dependent on dynamic viscoelasticity. One example technique to obtain a gelation temperature involves placing a small piece of iron sealed in a glass tube into a dilatometer. With the temperature varied, a temperature at which the piece of iron in the ink liquid stops free-falling is determined to be a phase transition point (J. Polym. Sci., 21, 57 (1956)). Another example technique involves placing an aluminum cylinder on an ink to be subjected to a temperature change for gelation. A temperature at which the aluminum cylinder begins free-falling is determined to be a gelation temperature (Nihon Reoroji Gakkaishi (Journal of the Society of Rheology, Japan), Vol. 17, 86 (1989)). An example simple technique involves placing a specimen in a gel state on a heat plate to be heated. A temperature at which the shape of the specimen collapses is determined to be a gelation temperature. Such a gelation temperature (phase transition temperature) of an ink can be controlled depending on the type of the gelling agent, the amount of the added gelling agent, and the type of the activating beam curable monomer.

The ink applied to the present invention preferably has a viscosity of 10² mPa·s or higher but lower than 10⁵ mPa·s at 25° C., and more preferably, of 10³ mPa·s or higher but lower than 10⁴ mPa·s. Ink having a viscosity of 10² mPa·s or higher can prevent poor image quality due to the integration of dots, while ink having a viscosity of lower than 10⁵ mPa·s can be properly leveled after being ejected onto a recording medium under a controlled surface temperature of the recording medium, and thus can provide homogeneous gloss. The viscosity of the ink can be effectively controlled depending on the type of the gelling agent, the amount of the added gelling agent, and the type of the activating beam curable monomer. The viscosity of the ink is observed with a stress controlled rheometer including a cone-plate (PhysicaMCR, Anton Paar, Ltd.), at a shear rate of 11.7 s⁻¹.

The gelling agent contained in the ink may be composed of a high-molecular compound or low-molecular compound; however, the gelling agent is preferably composed of a low-molecular compound for a good inkjet ejection.

Non-limiting specific examples of the gelling agents which can be formulated in the ink according to the present invention are listed below.

Specific examples of high-molecular compounds preferably used in the present invention include fatty acids with inulin, such as inulin stearate; dextrins of fatty acids, such as dextrin palmitate and dextrin myristate (Rheopearl, available from Chiba Flour Milling Co., Ltd.); glyceryl behenate/eicosadioate; and polyglyceryl behenate/eicosadioate (Nom Coat, available from The Nisshin Oillio Group, Ltd.).

Examples of low-molecular compounds preferably used in the present invention include oil gelling agents having low molecular weight; amid compounds, such as N-lauroyl-L-glutamic acid dibutylamide and N-2-ethylhexanoyl-L-glutamic acid dibutylamide (available from Ajinomoto Fine-Techno Co., Inc.); dibenzylidene sorbitol compounds, such as 1,3:2,4-bis-O-benzylidene-D-glucitol (Gell All D available from New Japan Chemical Co., Ltd.); petroleum-derived waxes, such as paraffin wax, micro crystalline wax, and petrolatum; plant-derived waxes, such as candelilla wax, carnauba wax, rice wax, Japan wax, jojoba oil, jojoba solid wax, and jojoba ester; animal-derived waxes, such as beewax, lanolin, and spermaceti; mineral waxes, such as montan wax and hydrogenated wax; denatured waxes such as hardened castor oil and hardened castor oil derivatives, montan wax derivatives, paraffin wax derivatives, micro crystalline wax derivatives, and polyethylene wax derivatives; higher fatty acids, such as behenic acid, arachidic acid, stearic acid, palmitic acid, myristic acid, lauric acid, oleic acid, and erucic acid; higher alcohols such as a stearyl alcohol and behenyl alcohol; hydroxystearic acids, such as 12-hydroxystearic acid; derivatives of 12-hydroxystearic acid; fatty acid amides, such as a lauric acid amide, stearic acid amide, behenic acid amide, oleic acid amide, erucic acid amide, ricinoleic acid amide, and 12-hydroxystearic acid amide (for example, Nikka Amide from Nippon Kasei Chemical Co., Ltd, ITOWAX available from Itoh Oil Chemicals Co., Ltd, and FATTYAMID available from Kao Corporation); N-substituted fatty acid amides, such as N-stearyl stearic acid amide, N-oleyl palmitic acid amide; special fatty acid amides, such as N,N′-ethylenebisstearylamide N,N′-ethylenebis(12-hydroxystearic amide), and N,N′-xylylene bisstearylamide; higher amines, such as dodecylamine, tetradecylamine, and octadecylamine; fatty acid esters, such as stearyl stearate, oleyl palmitate, glycerin fatty acid ester, sorbitan fatty acid ester, propylene glycol fatty acid ester, ethylene glycol fatty acid ester, and polyoxyethylene fatty acid ester (e.g., EMALLEX available from Nihon Emulsion Co., Ltd., Rikemal available from Riken Vitamin Co., Ltd., and Poem available from Riken Vitamin Co., Ltd.); sucrose fatty acid esters, such as sucrose stearate and sucrose palmitate (for example, Ryoto Sugar Ester available from Mitsubishi-Kagaku Foods Corporation); synthetic waxes, such as polyethylene wax and α-olefin maleic anhydride copolymer wax; polymerizable waxes (UNILIN from Baker-Petrolite Corporation); dimer acids and dimer diols (PRIPOR available from Croda International Plc); which are described in Japanese Unexamined Patent Application Publication Nos. 2005-126507, 2005-255821, and 2010-111790. These gelling agents may be used alone or in combination as appropriate.

The ink, which contains the gelling agent, is transformed into a gel state immediately after being ejected from an inkjet recording head onto a recording medium. This prevents the mixing and integration of dots and thus can provide high quality image during high-speed printing. The ink dots are then cured by activating beams to be fixed on the recording medium, forming a firm image film. The amount of the gelling agent included in the ink is preferably 1 percent by mass or more but less than 10 percent by mass, and more preferably, 2 percent by mass or more but less than 7 percent by mass. The ink containing the gelling agent in an amount of 1 percent by mass or more can be subjected to sufficient gelation and thus can prevent poor image quality due to the integration of the dots. Moreover, the ink drops having an increased viscosity after gelation prevent a decrease in photocurable properties due to oxygen inhibition when the ink is photo-radically cured. The ink containing the gelling agent of less than 10 percent by mass can prevent poor quality of a cured film due to non-cured component after irradiation with activating beams and can prevent poor inkjet ejection characteristics.

### (Activating Beam-Curable Compositions)

The activating-beam curable ink contains a gelling agent, coloring material, and an activating beam curable composition to be cured by activating beams.

The activating beam curable composition (hereinafter also referred to as “photopolymerizable compound”) will now be described.

Examples of the activating beams include electron beams, ultraviolet rays, α beams, γ beams, and x-rays; however, ultraviolet rays and electron beams are preferred that are less damaging the human body, easy to handle, and industrially widespread. In the present invention, ultraviolet rays are particularly preferred.

In the present invention, any photopolymerizable compound that can be cross-linked or polymerized by irradiation with activating beams may be used without limitation; and, photo-cationically or photo-radically polymerizable compounds are preferred.

### (Cationically Polymerizable Compound)

Any known cationically polymerizable monomers may be used; examples of the cationically polymerized monomers include epoxy compounds, vinyl ether compounds, and oxetane compounds described in Japanese Unexamined Patent Application Publication Nos. 6-9714, 2001-31892, 2001-40068, 2001-55507, 2001-310938, 2001-310937, and 2001-220526.

In the present invention, the photopolymerizable compound preferably contains at least one oxetane compound and at least one compound selected from an epoxy compound and a vinyl ether compound in order to prevent contraction of the recording medium during curing of the ink.

Preferred examples of aromatic epoxides include di- or poly-glycidyl ethers prepared by the reaction of polyhydric phenol having at least one aromatic nucleus or an alkylene oxide adduct thereof with epichlorohydrin, such as diglycidyl or polyglycidyl ethers of bisphenol A or an alkylene oxide adduct thereof, diglycidyl or polyglycidyl ethers of hydrogenated bisphenol A or an alkylene oxide adduct thereof, and novolac epoxy resin. Examples of the alkylene oxides include ethylene oxide and propylene oxide.

Preferred examples of alicyclic epoxides include a cyclohexene oxide-containing compound and a cyclopentane oxide-containing compound that are prepared by epoxidizing a compound having at least one cycloalkane ring such as a cyclohexene ring and a cyclopentene ring with a proper oxidant, such as hydrogen peroxide and a peracid.

Preferred examples of aliphatic epoxides include diglycidyl or polyglycidyl ethers of aliphatic polyhydric alcohols or alkylene oxide adducts thereof. Representative examples of the diglycidyl or polyglycidyl ethers include diglycidyl ethers of alkylene glycols, such as diglycidyl ether of ethylene glycol, diglycidyl ether of propylene glycol, and diglycidyl ether of 1,6-hexanediol; polyglycidyl ethers of polyhydric alcohols, such as diglycidyl ether or triglycidyl ether of glycerine or alkylene oxide adducts thereof; and diglycidyl ethers of polyalkylene glycols, such as diglycidyl ethers of polyethylene glycol or alkylene oxide adducts thereof, and diglycidyl ethers of polypropylene glycol or alkylene oxide adducts thereof. Examples of the alkylene oxides include ethylene oxide and propylene oxide.

Preferred epoxides among these epoxides are aromatic epoxides and alicyclic epoxides, and more preferred are alicyclic epoxides because of their rapid curability. In the present invention, the above-described epoxides may be used alone or in combination as appropriate.

Examples of vinyl ether compounds include di- or tri-vinyl ether compounds, such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, and trimethylolpropane trivinyl ether; and monovinyl ether compounds, such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether o-propylenecarbonate, dodecyl vinyl ether; diethylene glycol monovinyl ether, and octadecyl vinyl ether.

Preferred vinyl ether compounds among these vinyl ether compounds are di- or tri-vinyl ether compounds, and more preferred are di-vinyl ether compounds because of their curing properties, adhesion, and surface hardness. In the present invention, the above-described vinyl ether compounds may be used alone or in combination as appropriate.

The term “oxetane compound” used herein refers to a compound having one or more oxetane rings. Any known oxetane compound may be used, for example, described in Japanese Unexamined Patent Application Publication Nos. 2001-220526 and 2001-310937.

The use of an oxetane compound having five or more oxetane rings in the present invention may lead to an increase in viscosity of the ink composition. Such an ink composition is hard to handle, has a high glass transition temperature, and thus exhibits low adhesion after curing. The oxetane compound used in the present invention thus is preferably a compound having one to four oxetane rings.

Example of the oxetane compounds preferably used in the present invention include compounds represented by Formulae (1), (2), (7), (8), and (9) respectively described in paragraphs [0089], [0092], [0107], [0109], and [0166] of Japanese Unexamined Patent Application Publication No. 2005-255821.

Specific examples of the oxetane compounds include example compounds 1 to 6 described in paragraphs [0104] to [0119], and compounds described in paragraph [0121] of Japanese Unexamined Patent Application Publication No. 2005-255821.

### (Radically Polymerizable Compound)

A radically polymerizable compound will now be described.

Any known radically polymerizable monomers may be used as photo-radically polymerizable monomers. Example of the known radically polymerizable monomers include photo-curable material prepared using photo-polymerizable compounds, and cationically polymerizable photo-curable resin, which are described in Japanese Unexamined Patent Application Publication No. 7-159983, Japanese Examined Patent Application Publication No. 7-31399, and Japanese Unexamined Patent Application Publication Nos. 8-224982 and 10-863. In addition to these monomers, photo-cationically polymerizable photo-curable resin that is sensitized to light having wavelengths longer than those of visible light, may also be used as a photo-radically polymerizable monomer, the resin being described in Japanese Unexamined Patent Application Publication Nos. 6-43633 and No. 8-324137, for example.

Radically polymerizable compounds have radically polymerizable ethylenically unsaturated bonds. Any radically polymerizable compound that has at least one radically polymerizable ethylenically unsaturated bond in a molecule may be used that has a chemical form such as a monomer, oligomer, or polymer. Such radically polymerizable compounds may be used alone or in combination in any proportion to improve target properties.

Examples of the compounds having the radically polymerizable ethylenically unsaturated bond(s) include unsaturated carboxylic acids, such as acrylic acid, methacrylic acid, itaconic acid, crotonic acid, isocrotonic acid, and maleic acid, and salts, esters, urethanes, amides, anhydrides thereof; acrylonitrile; styrene; and radically polymerizable compounds such as various unsaturated polyesters, unsaturated polyethers, unsaturated polyamides, and unsaturated urethanes.

Any known (meth)acrylate monomers and/or oligomers may be used as radically polymerizable compounds. The term “and/or” used herein means that the radically polymerizable compound may be a monomer, oligomer, or combination thereof. The same is applied to the term “and/or” in the following description.

Example compounds having (meth)acrylate groups include monofunctional monomers, such as isoamyl acrylate, stearyl acrylate, lauryl acrylate, octyl acrylate, decyl acrylate, isomyristyl acrylate, isostearyl acrylate, 2-ethylhexyl diglycol acrylate, 2-hydroxybutyl acrylate, 2-acryloyloxyethyl hexahydrophthalate, butoxyethyl acrylate, ethoxydiethylene glycolacrylate, methoxydiethylene glycolacrylate, methoxypolyethylene glycolacrylate, methoxypropylene glycolacrylate, phenoxyethyl acrylate, tetrahydrofurfuryl acrylate, isobornyl acrylate, 2-hydroxyethyl acrylate, 2-hydroxypropyl acrylate, 2-hydroxy 3-phenoxypropyl acrylate, 2-acryloyloxy ethylsuccinic acid, 2-acryloyloxyethylphthalic acid, 2-acryloyloxyethyl 2-hydroxyethylphthalate, lactone modified flexible acrylate, and t-butylcyclohexyl acrylate; bifunctional monomers, such as triethylene glycol diacrylate, tetraethylene glycol diacrylate, polyethylene glycol diacrylate, tripropylene glycol diacrylate, polypropylene glycol diacrylate, 1,4-butanediol diacrylate, 1,6-hexanediol diacrylate, 1,9-nonanediol diacrylate, neopentyl glycol diacrylate, dimethylol tricyclodecane diacrylate, bisphenol-A PO-adduct diacrylate, hydroxypivalate neopentyl glycol diacrylate, and polytetramethylene glycol diacrylate; and multifunctional (tri- or higher functional) monomers, such as trimethylolpropane triacrylate, pentaerythritol triacrylate, pentaerythritol tetraacrylate, dipentaerythritol hexaacrylate, ditrimethylolpropane tetraacrylate, glycerine propoxy triacrylate, caprolactone-modified trimethylolpropane triacrylate, pentaerythritol ethoxy tetraacrylate, and caprolactam-modified dipentaerythritol hexaacrylate. In addition to these monomers, polymerizable oligomers may be used. Examples of the polymerizable oligomers include epoxy acrylates, aliphatic urethane acrylates, aromatic urethane acrylates, polyester acrylates, linear acylic oligomers. More specifically, commercially available or industrially known monomers, oligomers, and polymers that can be radically polymerized and crosslinked may be used, which are described in “Kakyozai Handobukku (Cross-linker Handbook)”, Shinzo Yamashita (Taiseisha, 1981); “UV•EB Kouka Handobukku (Genryo Hen) (UV•EB Curing Handbook (Material))”, Kiyomi Kato, (Koubunshi Kankoukai, 185); “UV•EB Koukagijyutsu no Ouyo to Shijyo (Application and Market of UV•EB Curing Technology)”, pp. 79, RadTech Japan (CMC Publishing Co., Ltd., 1989); “Poriesuteru Jyushi Handbook (Polyester Resin Handbook)”, Eiichiro Takiyama, (Nikkan Kogyo Shimbun Ltd., 1988).

Specific examples of the preferred monomers include isoamyl acrylate, stearyl acrylate, lauryl acrylate, octyl acrylate, decyl acrylate, isomyristyl acrylate, isostearyl acrylate, ethoxydiethylene glycol acrylate, methoxypolyethylene glycol acrylate, methoxypropylene glycol acrylate, isobornyl acrylate, lactone-modified flexible acrylate, tetraethylene glycol diacrylate, polyethylene glycol diacrylate, polypropylene glycol diacrylate, dipentaerythritol hexaacrylate, di(trimethylolpropane)tetraacrylate, glycerine propoxy triacrylate, caprolactone-modified trimethylolpropane triacrylate, pentaerythritol ethoxy tetraacrylate, and caprolactam-modified dipentaerythritol hexaacrylate in the light of their sensitivity, skin irritancy, eye irritancy, mutagenicity, and toxicity.

Specifically, more preferred monomers among these monomers are stearyl acrylate, lauryl acrylate, isostearyl acrylate, ethoxydiethylene glycol acrylate, isobornyl acrylate, tetraethylene glycol diacrylate, glyceryl propoxy triacrylate, caprolactone-modified trimethylolpropane triacrylate, and caprolactam-modified dipentaerythritol hexaacrylate.

The polymer of the present invention may be combinations of vinyl ether monomer and/or oligomer and (meth)acrylate monomer and/or oligomer. Examples of the vinyl ether monomers include di- or tri-vinyl ether compounds, such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, and trimethylolpropane trivinyl ether; and monovinyl ether compounds, such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether o-propylene carbonate, dodecyl vinyl ether, diethylene glycol monovinyl ether, and octadecyl vinyl ether. The vinyl ether oligomer is preferably a bifunctional vinyl ether compound having a molar weight of 300-1000 and two to three ester groups in a molecule. Non-limiting examples of such bifunctional vinyl ether compounds include VEctomer available from Sigma-Aldrich Co. LLC., such as VEctomer 4010, VEctomer 4020, VEctomer 4040, VEctomer 4060, and VEctomer 5015.

The polymer of the present invention may be combinations of various vinyl ether compounds and maleimide compounds. Non-limiting examples of the maleimide compounds include N-methylmaleimide, N-propylmaleimide, N-hexylmaleimide, N-laurylmaleimide, N-cyclohexylmaleimide, N-phenylmaleimide, N,N′-methylenebismaleimide, polypropylene glycol bis(3-maleimidepropyl)ether, tetraethylene glycol bis(3-maleimidepropyl)ether, bis(2-maleimide ethyl) carbonate, N,N′-(4,4′-diphenylmethane)bismaleimide, N,N′-2,4-tolylene bismaleimide, and multifunctional maleimide compounds which are ester compounds containing carboxylic acids and various polyols, the multifunctional maleimides compound being described in Japanese Unexamined Patent Application Publication No. 11-124403.

The amount of added cationic polymerizable compound or radically polymerizable compound described above is preferably within a range of 1 to 97 percent by mass, and more preferably, of 30 to 95 percent by mass.

### (Components of Ink)

Components, other than the components described above, of the ink of the present invention will now be described.

### (Color Material)

The ink may contain any dye or pigment as a color material. The preferred materials are pigments with stable dispersion in the ink components and weatherability. Examples of pigments according to the invention include, but not limited to, organic and inorganic pigments represented by the following color index numbers, which can be used in accordance with the purpose.

Red or magenta pigments: Pigment Reds 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, and 257; Pigment Violets 3, 19, 23, 29, 30, 37, 50, and 88; and Pigment Oranges 13, 16, 20, and 36.

Blue or cyan pigments: Pigment Blues 1, 15, 15:1, 15:2, 15:3, 15:4, 15:6, 16, 17-1, 22, 27, 28, 29, 36, and 60.

Green pigments: Pigment Greens 7, 26, 36, and 50.

Yellow pigments: Pigment Yellows 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Black pigments: Pigment Blacks 7, 28, and 26.

Specific examples of the pigments include CHROMOFINE YELLOWs 2080, 5900, 5930, AF-1300, and AF-2700L; CHROMOFINE ORANGEs 3700L and 6730; CHROMOFINE SCARLET 6750; CHROMOFINE MAGENTAs 6880, 6886, 6891N, 6790, and 6887; CHROMOFINE VIOLET RE; CHROMOFINE REDs 6820 and 6830; CHROMOFINE BLUEs HS-3, 5187, 5108, 5197, 5085N, SR-5020, 5026, 5050, 4920, 4927, 4937, 4824, 4933GN-EP, 4940, 4973, 5205, 5208, 5214, 5221, and 5000P; CHROMOFINE GREENs 2GN, 2GO, 2G-550D, 5310, 5370, and 6830; CHROMOFINE BLACK A-1103; SEIKAFAST YELLOWs 10GH, A-3, 2035, 2054, 2200, 2270, 2300, 2400(B), 2500, 2600, ZAY-260, 2700(B), and 2770; SEIKAFAST REDs 8040, C405(F), CA120, LR-116, 1531B, 8060R, 1547, ZAW-262, 1537B, GY, 4R-4016, 3820, 3891, and ZA-215; SEIKAFAST CARMINEs 6B1476T-7, 1483LT, 3840, and 3870; SEIKAFAST BORDEAUX 10B-430; SEIKALIGHT ROSE R40; SEIKALIGHT VIOLETs B800 and 7805; SEIKAFAST MAROON 460N; SEIKAFAST ORANGEs 900 and 2900; SEIKALIGHT BLUEs C718 and A612; CYANINE BLUEs 4933M, 4933GN-EP, 4940, and 4973 (Dainichiseika Color & Chemicals Mfg. Co., Ltd.); KET Yellows 401, 402, 403, 404, 405, 406, 416, and 424; KET Orange 501; KET Reds 301, 302, 303, 304, 305, 306, 307, 308, 309, 310, 336, 337, 338, and 346; KET Blues 101, 102, 103, 104, 105, 106, 111, 118, and 124; KET Green 201 (DIC Corporation), Colortex Yellows 301, 314, 315, 316, P-624, 314, U10GN, U3GN, UNN, UA-414, and U263; Finecol Yellows T-13 and T-05; Pigment Yellow 1705; Colortex Orange 202, Colortex Reds 101, 103, 115, 116, D3B, P-625, 102, H-1024, 105C, UFN, UCN, UBN, U3BN, URN, UGN, UG276, U456, U457, 105C, and USN; Colortex Maroon 601; Colortex Brown B610N; Colortex Violet 600; Pigment Red 122; Colortex Blues 516, 517, 518, 519, A818, P-908, and 510; Colortex Greens 402 and 403; Colortex Blacks 702 and U905 (Sanyo Color Works. LTD.); Lionol Yellow 1405G; Lionol Blues FG7330, FG7350, FG7400G, FG7405G, ES, and ESP-S (Toyo Ink SC Holdings Co., Ltd.); Toner Magenta E02; Permanent Rubin F6B; Toner Yellow HG; Permanent Yellow GG-02; Hostaperm Blue B2G (Hoechst Industry Ltd.); Novoperm P-HG; Hostaperm Pink E; Hostaperm Blue B2G (Clariant International Ltd.); and Carbon Blacks #2600, #2400, #2350, #2200, #1000, #990, #980, #970, #960, #950, #850, MCF88, #750, #650, MA600, MA7, MA8, MA11, MA100, MA100R, MA77, #52, #50, #47, #45, #45L, #40, #33, #32, #30, #25, #20, #10, #5, #44, and CF9 (Mitsubishi Chemical Corporation).

The pigments may be dispersed, for example, with a ball mill, a sand mill, an attritor, a roll mill, an agitator, a Henschel mixer, a colloid mill, an ultrasonic homogenizer, a pearl mill, a wet jet mill, or a paint shaker.

A dispersant may be added for dispersion of the pigments. The preferred dispersant is a polymer dispersant. Examples of polymer dispersants include Solsperse® series by Avecia Inc., PB series by Ajinomoto Fine-Techno Co., Inc., and the following materials.

Pigment dispersants: hydroxyl-containing carboxylic acid esters, salts of long-chain polyaminoamides and high-molecular-weight acid esters, salts of high-molecular-weight polycarboxylic acids, salts of long-chain polyaminoamides and polar acid esters, high-molecular-weight unsaturated acid esters, copolymers, modified polyurethanes, modified polyacrylates, polyether-ester anionic surfactants, salts of naphthalenesulfonic acid-formalin condensates, salts of aromatic sulfonic acid-formalin condensates, polyoxyethylene alkyl phosphate esters, polyoxyethylene nonylphenyl ethers, stearylamine acetates, and pigment derivatives.

Specific examples of polymer dispersants include: ANTI-TERRA-U (polyaminoamide phosphate salt), ANTI-TERRA-203 and ANTI-TERRA-204 (high-molecular-weight polycarboxylates), DISPERBYK-101 (polyaminoamide phosphate and acid ester), DISPERBYK-107 (hydroxyl group-containing carboxylic acid ester), DISPERBYK-110 (copolymer containing acid group), DISPERBYK-130 (polyamide), DISPERBYK-161, -162, -163, -164, -165, -166, and -170 (high molecular weight copolymers), 400, Bykumen (high-molecular-weight unsaturated acid ester), BYK-P104 and BYK-P105 (high-molecular-weight unsaturated polycarboxylic acids), BYK-P104S and -P240S (high molecular weight unsaturated polycarboxylic acids and silicon), and Lactimon (long-chain amine, unsaturated polycarboxylic acid, and silicon) by BYK-Chemie GmbH.

Further examples include: Efkas 44, 46, 47, 48, 49, 54, 63, 64, 65, 66, 71, 701, 764, and 766, Efka Polymers 100 (modified polyacrylate), 150 (aliphatic modified polymer), 400, 401, 402, 403, 450, 451, 452, 453 (modified polyacrylates), and 745 (copper phthalocyanine) by Efka Chemicals B.V.; FLOWREN TG-710 (urethane oligomer), FLOWNONs SH-290 and SP-1000, POLYFLOW Nos. 50E and 300 (acrylic copolymers) by Kyoeisha Chemical Co., Ltd.; Disparlons KS-860, 873SN, and 874 (polymer dispersants), and Disparlon #2150 (aliphatic polyvalent carboxylic acid) and #7004 (polyether ester) by Kusumoto Chemicals, Ltd.

Still further examples include: DEMOLs RN, N (sodium naphthalene sulfonate-formaldehyde condensates), MS, C, SN-B (sodium aromatic sulfonate-formaldehyde condensates), and EP, HOMOGENOL L-18 (polycarboxylic polymer), EMULGENs 920, 930, 931, 935, 950, and 985 (polyoxyethylene nonylphenyl ethers), ACETAMINs 24 (coconut amine acetate), and 86 (stearyl amine acetate) by Kao Corporation; SOLSPERSEs 5000 (phthalocyanine ammonium salt), 13240, 13940 (polyester amines), 17000 (aliphatic amine), 24000, and 32000 by AstraZeneca plc; and NIKKOL T106 (polyoxyethylene sorbitan monooleate), MYS-IEX (polyoxyethylene monostealate), and Hexagline 4-0 (hexaglyceryl tetraoleate) by Nikko Chemicals Co., Ltd.

The ink preferably contains a pigment dispersant in an amount of 0.1 to 20 percent by mass. Synergists dedicated to the respective pigments may be used as dispersion aids. The dispersant and dispersion aids are preferably added in amounts of 1 to 50 parts by mass for 100 parts by mass of pigments. A dispersion medium may be a solvent or a polymerizable compound. Preferably, the ink, which is subjected to reaction and curing after printing, contains no solvent. Residual solvent, which is a volatile organic compound (VOC), in cured-ink images causes a decrease in solvent resistance and environmental issues. The preferred dispersion media are therefore polymerizable compounds, especially a monomer with the lowest viscosity rather than a solvent, in view of dispersion characteristics.

The pigment preferably has an average particle diameter in the range of 0.08 to 0.5 μm and a maximum diameter of 0.3 to 10 μm, more preferably 0.3 to 3 μm in view of dispersion of the pigment. These diameters are appropriately determined depending on the types of the pigment itself, dispersant, and dispersion medium, dispersion conditions, and filtration conditions. Such size control prevents nozzle clogging in the recording heads and leads to high storage stability, transparency, and curing sensitivity of the ink.

The ink may optionally contain a known dye, preferably an oil-soluble dye. Non-limiting oil-soluble dyes that can be used in the present invention are listed below.

### (Magenta Dye)

MS Magenta VP, MS Magenta HM-1450, and MS Magenta HSo-147 (Mitsui Chemicals, Inc.); AIZENSOT Red-1, AIZEN SOT Red-2, AIZEN SOT Red-3, AIZEN SOT Pink-1, and SPIRON Red GEH SPECIAL (Hodogaya Chemical Co., Ltd.); RESOLIN Red FB 200%, MACROLEX Red Violet R, and MACROLEX ROT5B (Bayer); KAYASET Red B, KAYASET Red 130, and KAYASET Red 802 (Nippon Kayaku Co., Ltd.); PHLOXIN, ROSE BENGAL, and ACID Red (Daiwa Kasei Co., Ltd.); HSR-31 and DIARESIN Red K (Mitsubishi Chemical Corporation); and Oil Red (BASF Japan Ltd.).

### (Cyan Dye)

MS Cyan HM-1238, MS Cyan HSo-16, Cyan HSo-144, and MS Cyan VPG (Mitsui Chemicals, Inc.); AIZEN SOT Blue-4 (Hodogaya Chemical Co., Ltd.); RESOLIN BR.Blue BGLN 200%, MACROLEX Blue RR, CERES Blue GN, SIRIUS SUPRA TURQ.Blue Z-BGL, and SIRIUS SUPRA TURQ.Blue FB-LL 330% (Bayer); KAYASET Blue FR, KAYASET Blue N, KAYASET Blue 814, Turq.Blue GL-5 200, and Light Blue BGL-5 200 (Nippon Kayaku Co., Ltd.); DAIWA Blue 7000 and Oleosol Fast Blue GL (Daiwa Kasei Co., Ltd.); DIARESIN Blue P (Mitsubishi Chemical Corporation); and SUDAN Blue 670, NEOPEN Blue 808, and ZAPON Blue 806 (BASF Japan Ltd.).

### (Yellow Dye)

MS Yellow HSm-41, Yellow KX-7, and Yellow EX-27 (Mitsui Chemicals, Inc.); AIZEN SOT Yellow-1, AIZEN SOT YelloW-3, and AIZEN SOT Yellow-6 (Hodogaya Chemical Co., Ltd.); MACROLEX Yellow 6G and MACROLEX FLUOR.Yellow 10GN (Bayer); KAYASET Yellow SF-G, KAYASET Yellow 2G, KAYASET Yellow A-G, and KAYASET Yellow E-G (Nippon Kayaku Co., Ltd.); DAIWA Yellow 330HB (Daiwa Kasei Co., Ltd.); HSY-68 (Mitsubishi Chemical Corporation); and SUDAN Yellow 146 and NEOPEN Yellow 075 (BASF Japan Ltd.).

### (Black Dye)

MS Black VPC (Mitsui Chemicals, Inc.); AIZEN SOT Black-1 and AIZEN SOT Black-5 (Hodogaya Chemical Co., Ltd.); RESORIN Black GSN 200% and RESOLIN BlackBS (Bayer); KAYASET Black A-N (Nippon Kayaku Co., Ltd.); DAIWA Black MSC (Daiwa Kasei Co., Ltd.); HSB-202 (Mitsubishi Chemical Corporation); and NEPTUNE Black X60 and NEOPEN Black X58 (BASF Japan Ltd.).

The pigments or oil-soluble dyes are preferably added in amounts of 0.1 to 20 percent by mass, more preferably 0.4 to 10 percent by mass. Addition of 0.1 percent by mass or more yields desirable image quality, and addition of 20 percent by mass or less provides appropriate ink viscosity during ejection of ink. Two or more colorants may be appropriately used for color adjustment.

### (Photopolymerization Initiator)

The ink preferably contains at least one photopolymerization initiator when ultraviolet rays, for example, are used as activating beams. For use of electron beams as activating beams, no photopolymerization initiator is necessary in many cases.

Photopolymerization initiators are broadly categorized into two types: an intramolecular bonding cleavage type and an intramolecular hydrogen abstraction type.

Photopolymerization initiators of the intramolecular bonding cleavage type include acetophenones, such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy)phenyl 2-hydroxy-2-propyl ketone, 1-hydroxycyclohexyl phenyl ketone, 2-methyl-2-morpholino(4-thiomethylphenyl)propan-1-one, and 2-benzyl-2-dimethylamino-1-(4-morpholinophenyl)-butanone; benzoins, such as benzoin, benzoin methyl ethers, and benzoin isopropyl ethers; acylphosphine oxides, such as 2,4,6-trimethyl benzoin diphenylphosphine oxide; benzyl; and methyl phenylglyoxylate.

Photopolymerization initiators of the intramolecular hydrogen abstraction type include benzophenones, such as benzophenone, o-benzoylbenzoic acid, methyl-4-phenyl benzophenone, 4,4′-dichlorobenzophenone, hydroxybenzophenone, 4-benzoyl-4′-methyl diphenyl sulfide, acrylated benzophenone, 3,3′,4,4′-tetra(t-butylperoxycarbonyl)benzophenone, and 3,3′-dimethyl-4-methoxy benzophenone; thioxanthones, such as 2-isopropylthioxanthone, 2,4-dimethylthioxanthone, 2,4-diethylthioxanthone, and 2,4-dichlorothioxanthone; aminobenzophenones, such as Michler's ketone and 4,4′-diethylamino benzophenone; 10-butyl-2-chloroacridone; 2-ethylanthraquinone; 9,10-phenanthrenequinone; and camphorquinone.

The preferred amount of a photopolymerization initiator, if used, is 0.01 to 10 percent by mass of an activating beam curable composition.

Examples of the radical polymerization initiators include triazine derivatives disclosed in documents, such as Japanese Examined Patent Application Publication Nos. S59-1281 and S61-9621, and Japanese Unexamined Patent Application Publication No. S60-60104; organic peroxides disclosed in documents, such as Japanese Unexamined Patent Application Publication Nos. S59-1504 and S61-243807; diazonium compounds disclosed in documents, such as Japanese Examined Patent Application Publication Nos. S43-23684, S44-6413, S44-6413, and S47-1604 and U.S. Pat. No. 3,567,453; organic azide compounds disclosed in documents, such as U.S. Pat. Nos. 2,848,328, 2,852,379, and 2,940,853; orthoquinonediazides disclosed in documents, such as Japanese Examined Patent Application Publication Nos. S36-22062, S37-13109, S38-18015, and S45-9610; onium compounds disclosed in documents, such as Japanese Examined Patent Application Publication No. S55-39162 and Japanese Unexamined Patent Application Publication No. S59-14023 and Macromolecules, 10, P. 1307, 1977; azo compounds disclosed in Japanese Unexamined Patent Application Publication No. S59-142205; metal allene complexes disclosed in documents, such as Japanese Unexamined Patent Application Publication No. H1-54440, EP patent Nos. 109,851 and 126,712 and J. Imag. Sci., 30, P. 174, 1986; (oxo)sulfonium organoboron complexes disclosed in Japanese Patent Nos. 2711491 and 2803454; titanocene dichlorides disclosed in Japanese Unexamined Patent Publication No. S61-151197; transition metal complexes containing transition metals, such as ruthenium disclosed in Coordination Chemistry Review, 84, pp. 85-277, 1988 and Japanese Unexamined Patent Application Publication No. H2-182701; 2,4,5-triarylimidazole dimer; carbon tetrabromide disclosed in Japanese Unexamined Patent Application Publication No. H3-209477; and organic halogen compounds disclosed in Japanese Unexamined Patent Application Publication No. S59-107344. The preferred amount of a polymerization initiator ranges from 0.01 to 10 parts by mass for 100 parts by mass of a compound containing a radically polymerizable

ethylenically unsaturated bond.

The ink may contain a photoacid generator serving as a photopolymerization initiator.

As photoacid generators, compounds that are used, for example, for a chemically amplified photoresist or photo cationic polymerization are used (The Japanese Research Association for Organic Electronics Materials (ed.), Organic materials for imaging, pp. 187-192, BUNSHIN, 1993). Examples of such a compound suitable for the present invention are as follows.

First group: salts of aromatic onium compounds, such as diazonium, ammonium, iodonium, sulfonium, and phosphonium with B(C₆F₅)₄⁻, PF₆⁻, AsF₆⁻, SbF₆⁻, or CF₃SO₃⁻.

Specific examples of the onium compound usable in the invention are disclosed in paragraph [0132] of Japanese Unexamined Patent Publication No. 2005-255821.

Second group: sulfonated compounds generating sulfonic acid. Specific examples of such a sulfonated compound are disclosed in paragraph [0136] of Japanese Unexamined Patent Publication No. 2005-255821.

Second group: halides photogenerating hydrogen halide. Specific examples of such a halide are disclosed in paragraph [0138] of Japanese Unexamined Patent Publication No. 2005-255821.

Third group: iron-allene complexes disclosed in paragraph [0140] of Japanese Unexamined Patent Publication No. 2005-255821.

### (Other Addictive Agents)

The activating beam curable ink may also contain a variety of additives, other than those described above. Examples of such additives include surfactants, leveling agents, matting agents, polyester resins for adjusting membrane properties, polyurethane resins, vinyl resins, acrylic resins, elastomeric resins, and waxes. Any known basic compound can be used for improvement in storage stability. Typical examples include basic alkali metal compounds, basic alkali earth metal compounds, and basic organic compounds, such as amines.

Inks used in this embodiment are listed below.

Pigment dispersion elements for the following ink composition are obtained by heating and stirring a mixture of 5 parts by mass of SOLSPERSE 32000 (Lubrizol Corporation) and 80 parts by mass of HD-N (1,6-hexanediol dimethacrylate: Shin-Nakamura Chemical Co., Ltd.) in a stainless steel beaker to dissolve the mixture, cooling the mixture to room temperature, adding 15 parts by mass of Carbon Black #56 (Mitsubishi Chemical Corporation) to the mixture, putting the mixture and zirconia beads of 0.5 mm in a sealed glass vial, performing dispersion of the mixture with a paint shaker for 10 hours, and removing the zirconia beads therefrom.

TABLE 1

| | | | AMOUNT |
|---|---|---|---|
| | NAME | MANUFACTURER | (PART) |
| POLYMERIZABLE | A-600 | SHIN-NAKAMURA | 50 |
| COMPOUND | | CHEMICAL CO., | |
| | | LTD. | |
| POLYMERIZABLE | A-GLY-9E | SHIN-NAKAMURA | 5 |
| COMPOUND | | CHEMICAL CO., | |
| | | LTD. | |
| POLYMERIZABLE | HD-N | SHIN-NAKAMURA | 4.85 |
| COMPOUND | | CHEMICAL CO., | |
| | | LTD. | |
| PIGMENT DISPERSION | | | 20 |
| ELEMENT | | | |
| GELLING AGENT | KAO WAX T-1 | KAO CORPORATION | 5 |
| PHOTOPOLYMERIZATION | IRGACURE 379 | BASF | 3 |
| INITIATOR | | | |
| PHOTOPOLYMERIZAT1ON | DAROCUR TPO | BASF | 5 |
| INITIATOR | | | |
| SENSITIZER | KAYACURE | NIPPON KAYAKU | 2 |
| | DETX-S | CO., LTD. | |
| POLYMERIZATION | UV-10 | BASF | 0.1 |
| INHIBITOR | | | |
| SURFACTANT | KF351 | SHIN-ETSU | 0.05 |
| | | CHEMICAL CO., | |
| | | LTD. | |

TABLE 2

| | | | AMOUNT |
|---|---|---|---|
| | NAME | MANUFACTURER | (PART) |
| POLYMERIZABLE | 9G | SHIN-NAKAMURA | 35 |
| COMPOUND | | CHEMICAL CO., | |
| | | LTD. | |
| POLYMERIZABLE | U-200PA | SHIN-NAKAMURA | 5 |
| COMPOUND | | CHEMICAL CO., | |
| | | LTD. | |
| POLYMERIZABLE | 3G | SHIN-NAKAMURA | 19.85 |
| COMPOUND | | CHEMICAL CO., | |
| | | LTD. | |
| PIGMENT DISPERSION | | | 20 |
| ELEMENT | | | |
| GELLING AGENT | KAO WAX T-1 | KAO CORPORATION | 5 |
| PHOTOPOLYMERIZATION | DAROCUR TPO | BASF | 3 |
| INITIATOR | | | |
| SENSITIZER | PROCURE TPO | BASF | 5 |
| SENSITIZER | KAYACURE | NIPPON KAYAKU | 2 |
| | DETX-S | CO., LTD. | |
| POLYMERIZATION | UV-10 | BASF | 0.1 |
| INHIBITOR | | | |
| SURFACTANT | KF351 | SHIN-ETSU | 0.05 |
| | | CHEMICAL CO., | |
| | | LTD. | |

TABLE 3

| | | | AMOUNT |
|---|---|---|---|
| | NAME | MANUFACTURER | (PART) |
| POLYMERIZABLE | 14G | SHIN-NAKAMURA | 45 |
| COMPOUND | | CHEMICAL CO., | |
| | | LTD. | |
| POLYMERIZABLE | A-HD-N | SHIN-NAKAMURA | 14.85 |
| COMPOUND | | CHEMICAL CO., | |
| | | LTD. | |
| PIGMENT DISPERSION | | | 20 |
| ELEMENT | | | |
| GELLING AGENT | KAO WAX T-1 | KAO CORPORATION | 5 |
| PHOTOPOLYMERIZATION | IRGACURE 379 | BASF | 3 |
| INITIATOR | | | |
| PHOTOPOLYMERIZATION | DAROCUR TPO | BASF | 5 |
| INITIATOR | | | |
| SENSITIZER | KAYACURE | NIPPON KAYAKU | 2 |
| | DETX-S | CO., LTD. | |
| POLYMERIZATION | UV-10 | BASF | 0.1 |
| INHIBITOR | | | |
| SURFACTANT | KF351 | SHIN-ETSU | 0.05 |
| | | CHEMICAL CO., | |
| | | LTD. | |

TABLE 4

| | | | AMOUNT |
|---|---|---|---|
| | NAME | MANUFACTURER | (PART) |
| POLYMERIZABLE | UA-4200 | SHIN-NAKAMURA | 35 |
| COMPOUND | | CHEMICAL CO., | |
| | | LTD. | |
| POLYMERIZABLE | A-HD-N | SHIN-NAKAMURA | 24.85 |
| COMPOUND | | CHEMICAL CO., | |
| | | LTD. | |
| PIGMENT DISPERSION | | | 20 |
| ELEMENT | | | |
| GELLING AGENT | KAO WAX T-1 | KAO CORPORATION | 5 |
| PHOTOPOLYMERIZATION | IRGACURE 379 | BASF | 3 |
| INITIATOR | | | |
| PHOTOPOLYMERIZATION | DAROCUR TPO | BASF | 5 |
| INITIATOR | | | |
| SENSITIZER | KAYACURE | NIPPON KAYAKU | 2 |
| | DETX-S | CO., LTD. | |
| POLYMERIZATION | UV-10 | BASF | 0.1 |
| INHIBITOR | | | |
| SURFACTANT | KF351 | SHIN-ETSU | 0.05 |
| | | CHEMICAL CO., | |
| | | LTD. | |

TABLE 5

| | | | AMOUNT |
|---|---|---|---|
| | NAME | MANUFACTURER | (PART) |
| POLYMERIZABLE | AD-TMP | SHIN-NAKAMURA | 30 |
| COMPOUND | | CHEMICAL CO., | |
| | | LTD. | |
| POLYMERIZABLE | A-GLY-9E | SHIN-NAKAMURA | 20 |
| COMPOUND | | CHEMICAL CO., | |
| | | LTD. | |
| POLYMERIZABLE | HD-N | SHIN-NAKAMURA | 9.85 |
| COMPOUND | | CHEMICAL CO., | |
| | | LTD. | |
| PIGMENT DISPERSION | | | 20 |
| ELEMENT | | | |
| GELLING AGENT | KAO WAX T-1 | KAO CORPORATION | 5 |
| PHOTOPOLYMERIZATION | IRGACURE 379 | BASF | 3 |
| INITIATOR | | | |
| PHOTOPOLYMERIZATION | DAROCUR TPO | BASF | 5 |
| INITIATOR | | | |
| SENSITIZER | KAYACURE | NIPPON KAYAKU | 2 |
| | DETX-S | CO., LTD. | |
| POLYMERIZATION | UV-10 | BASF | 0.1 |
| INHIBITOR | | | |
| SURFACTANT | KF351 | SHIN-ETSU | 0.05 |
| | | CHEMICAL CO., | |
| | | LTD. | |

TABLE 6

| | | | AMOUNT |
|---|---|---|---|
| | NAME | MANUFACTURER | (PART) |
| POLYMERIZABLE | U-200PA | SHIN-NAKAMURA | 13 |
| COMPOUND | | CHEMICAL CO., | |
| | | LTD. | |
| POLYMERIZABLE | A-GLY-9E | SHIN-NAKAMURA | 5 |
| COMPOUND | | CHEMICAL CO., | |
| | | LTD. | |
| POLYMERIZABLE | HD-N | SHIN-NAKAMURA | 41.85 |
| COMPOUND | | CHEMICAL CO., | |
| | | LTD. | |
| PIGMENT DISPERSION | | | 20 |
| ELEMENT | | | |
| GELLING AGENT | KAO WAX T-1 | KAO CORPORATION | 5 |
| PHOTOPOLYMERIZATION | IRGACURE 379 | BASF | 3 |
| INITIATOR | | | |
| PHOTOPOLYMERIZATION | DAROCUR TPO | BASF | 5 |
| INITIATOR | | | |
| SENSITIZER | KAYACURE | NIPPON KAYAKU | 2 |
| | DETX-S | CO., LTD. | |
| POLYMERIZATION | UV-10 | BASF | 0.1 |
| INHIBITOR | | | |
| SURFACTANT | KF351 | SHIN-ETSU | 0.05 |
| | | CHEMICAL CO., | |
| | | LTD. | |

### INDUSTRIAL APPLICABILITY

An inkjet recording device according to the present invention has industrial applicability in the field of image formation using an ink whose phase changes depending on temperature.

### REFERENCE NUMERALS

1 inkjet recording device
2 recording medium fixing section
3 suction pump
41 inkjet recording heads
6 recording medium holding layer
61 sticking holes
7 support layer
71 suction holes
M recording medium

1. An inkjet recording device using an ink which changes phase between a gel state or a solid state and a liquid state depending on temperature, the device comprising:
a recording medium fixing section to which a recording medium sticks to be fixed thereon with an air suction through sticking holes to come into contact with the recording medium;
a negative pressure generation section to generate a negative pressure for the air suction; and
an inkjet recording head to eject the ink in the liquid state onto the recording medium,
wherein the recording medium fixing section includes:
a recording medium holding layer to be maintained at a temperature for the ink to be in the gel state or the solid state, the recording medium holding layer having the sticking holes; and
a support layer including at least one layer to support the recording medium holding layer, the support layer having suction holes communicating with the sticking holes, and
wherein each of the sticking holes has an open end to come into contact with the recording medium, the open end having an opening area smaller than an opening area of an open end of each of the suction holes, the open end of each of the suction holes being in contact with the recording medium holding layer.

2. The inkjet recording device according to claim 1, wherein a maximum circle fitting inside an opening of the open end of each of the sticking holes to come into contact with the recording medium has a diameter D satisfying the relation of D≦4t, wherein t is a thickness of the recording medium.

3. The inkjet recording device according to claim 1, wherein an aperture ratio represented by an opening area of the sticking holes occupying a surface region of the recording medium holding layer to come into contact with the recording medium is 5% or more and 75% or less.

4. The inkjet recording device according to claim 1, wherein the recording medium holding layer has a thickness of 0.05 mm or more and 0.4 mm or less.

5. The inkjet recording device according to claim 1, wherein the recording medium holding layer is made of stainless steel.

6. The inkjet recording device according to claim 1, further comprising a heater to heat the recording medium fixing section to a predetermined temperature.

7. The inkjet recording device according to claim 1, wherein the recording medium has a thickness of 0.15 mm or less.
